(19) United States
(12) Patent Application Publication
(10) Pub. No.: US 2011/0109260 A1
(43) Pub. Date: May 12, 2011

(54) SUN SENT POWER SYSTEMS

(76) Inventor: Robert Trowbridge, Napa, CA (US)

(21) Appl. No.: 12/942,865

(22) Filed: Nov. 9, 2010

Related U.S. Application Data
(60) Provisional application No. 61/260,176, filed on Nov. 11, 2009.

(51) Int. Cl. H01M 10/46

(52) U.S. Cl. 320/101

(57) ABSTRACT

Sun sent power systems comprises a solar battery recharging assembly for children's electric toy vehicles (such as electric scooters, electric riding power vehicles and other such electrically powered outdoor riding toys). The solar battery recharging assembly comprises an array of photovoltaic panels having a plurality of solar cells to convert sun light into DC power to operate the toy vehicle. Sun sent power systems may be used to power and recharge virtually any outdoor electric toy substantially eliminating the need for users to have to plug the toys into standard electric outlets. The solar powering means of the photovoltaic panels enable the power toys to be continuously recharged while in use, thereby extending the duration of playtime and battery life. The item may be OEM installed or may be comprise an add-on converter kit for removable installment to an existing toy vehicle.

### CROSS-REFERENCE TO RELATED APPLICATION

The present application is related to and claims priority from prior provisional application Ser. No. 61/260,176, filed Nov. 11, 2009 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

1. Field of the Invention

The present invention relates generally to the field of solar powered children's toys and more specifically relates to a novel solar battery recharging system for removable attachment to a children's power toy thereby providing a self-recharging and powering energy source for continuous, uninterrupted use.

2. Description of the Related Art

Many young children enjoy countless hours of entertainment provided by electric riding toys such as electric cars or scooters. The problem with these toys is that they may have a limited operating battery life and must be plugged in to be recharged. It is easy for children and parents alike to forget to plug the toys in. This may result in the child's disappointment when the next time they go to play with the toy they discover that it is out of charge and thus unable to run. This situation can often result in a temper tantrum or other unpleasant reactions on the part of the child. Parents and children need an easier charging method for their power toys.

Various attempts have been made to solve the above-mentioned problems such as those found in U.S. Pat. Nos. 2007/0272465 to Chien-Ching Su; 5,894,898 to Craig C. Catto; 6,021,862 to Anand M. Sharan; 4,274,647 to Louis V. Drake et al; 5,725,062 to Paul A. Fronek; and 4,456,277 to Alan E. Carpenter. This prior art is representative of solar energized children's toys. None of the above inventions and patents, taken either singly or in combination, is seen to describe the invention as claimed.

Ideally, a solar powered and solar rechargeable battery system for a children's power toy should operate reliably and be manufactured at a modest expense. Thus, a need exists for a reliable solar battery recharging system to receive and convert solar power to energize a children's power toy and to avoid the above-mentioned problems.

### BRIEF SUMMARY OF THE INVENTION

In view of the foregoing disadvantages inherent in the known solar powered vehicle toy art, the present invention provides a novel solar powered recharging system for children's power toys. The general purpose of the present invention, which will be described subsequently in greater detail, is to provide a solar recharging battery system for retro market or aftermarket installation to operate and power children's power toys such as various types of toy vehicles.

Sun sent power system is designed to use solar power to charge battery-operated children's outdoor riding toys such as cars and scooters. This sun sent power system may comprise a solar battery recharging assembly available in at least two forms. One form may be a solar battery recharging assembly manufactured OEM on brand new toy vehicles and the second form may be an aftermarket retro-fit converter add-on kit for removable installment to an existing toy vehicle. The solar battery recharging assembly may comprise an array of two, four, or more photovoltaic panels mounted preferably to the top exterior of the toy vehicle with a wiring assembly for connecting the photovoltaic panels to either a 6-volt or 12-volt rechargeable battery that serves as the main power source. Each photovoltaic panel may comprise a plurality of solar cells for converting sun light into electricity. A diode may be connected to the positive wires restricting the energy flow to one direction, from the photovoltaic panel to the battery. This feature may allow the battery to maintain its charge rather than draining it when no solar energy is present.

An after market converter kit may be installed by parents or caregivers into existing toys. This item may be comprised of heavy plastic, plexi-glass, or other suitable materials and may look similar to a conventional blower that attaches to the hood of a car. It may be secured to the vehicle toy a fastener comprising a doubled-sided mounting tape or other suitable durable securing methods such as Velcro® (hook and loop).

The present invention holds significant improvements and serves as a solar powered recharging system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, solar powered recharging system, constructed and operative according to the teachings of the present invention.

FIG. 1 shows a perspective view illustrating a solar powered recharging system in an in-use condition comprising two photovoltaic panels installed to an exterior surface of a toy vehicle.

FIG. 2 is a perspective view illustrating a wiring assembly attached to a 6-volt rechargeable battery according to an embodiment of the present invention of FIG. 1.

FIG. 3 is a perspective view illustrating the solar powered recharging system in an in-use condition comprising four photovoltaic panels installed to an exterior surface of a toy vehicle to power a 12-volt rechargeable battery according to an alternative embodiment of the present invention.

FIG. 4 is a rear perspective view illustrating photovoltaic panels comprising a flexible material installed to a top exterior of a toy power car according to an embodiment of the present invention of FIG. 3.

FIG. 5 is a front perspective view illustrating an add-on kit of the solar powered recharging system installed to a toy power jeep according to an alternative embodiment of the present invention.

FIG. 6 is a flowchart illustrating a method of use according to an embodiment of the present invention.

The various embodiments of the present invention will hereinafter be described in conjunction with the appended drawings, wherein like designations denote like elements.

### DETAILED DESCRIPTION

As discussed above, embodiments of the present invention relate to a solar battery recharging system and more particularly to a solar battery recharging system as used to improve the continued use and enjoyment of motorized toy vehicles via solar energy. Sun sent power systems generally may comprise a line of solar powered battery kits for children's electric scooters, electric riding power vehicles, and other such electrically powered outdoor riding toys. The present invention may be used to power and recharge virtually any outdoor electric toy, thereby substantially eliminating the need for users to have to plug the toys into standard AC outlets. The present invention may be available as a standard OEM feature on newly manufactured toys as well an aftermarket add-on feature that parents may purchase to retro-fit to existing toys.

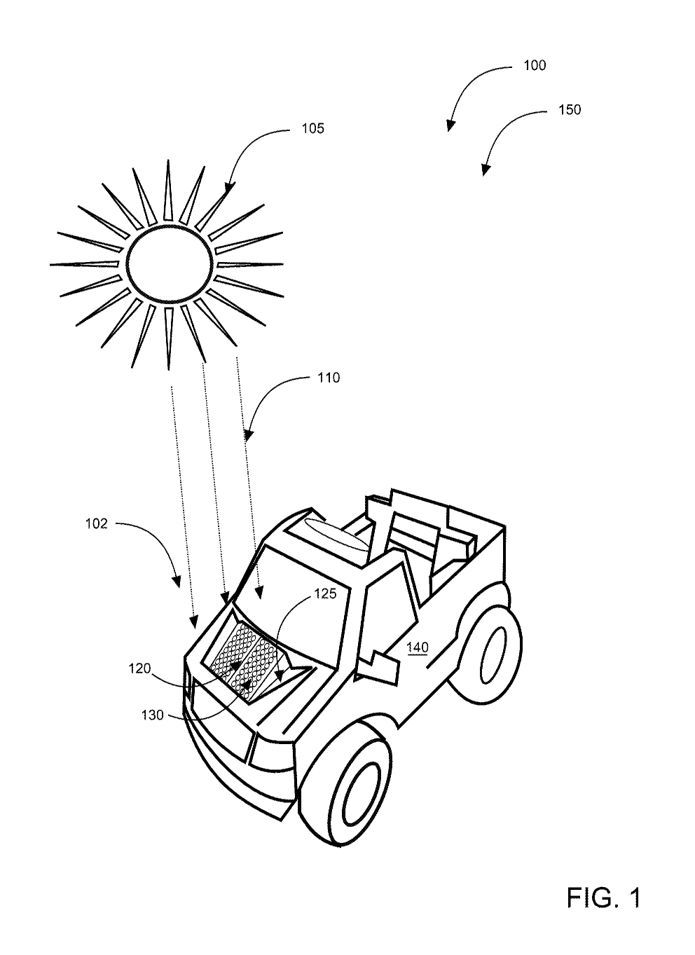

In referring to the drawings in greater detail, FIG. 1 is a perspective view illustrating sun sent power systems 100 installed to toy vehicle 140 in an in-use condition 150. In the embodiment of the present invention shown in FIG. 1, sun sent power systems 100 comprises solar battery recharging assembly 102 having two photovoltaic panels 120 and preferably two fasteners 125 for installing photovoltaic panels 120 to exterior surface of toy vehicle 140. An exposed top surface of photovoltaic panel 120 may comprise a plurality of solar cells 130 which are arranged in an interconnected assembly. While in use during daylight hours, sun light 110 emitted from sun 105 contacts solar cells 130 of photovoltaic panel 120. As will be discussed subsequently in greater detail, solar cell 130 of photovoltaic panel 120 converts sun light 110 (photons) emitted from sun 105 into DC electricity which is deliverable to 6-volt rechargeable battery 225 via wiring assembly 200 thereby providing power to operate toy vehicle 140. As seen in FIG. 1, photovoltaic panels 120 may be attached to top hood portion of toy vehicle 140. Two photovoltaic panels 120 may convert enough electricity to recharge and operate 6-volt rechargeable battery 225.

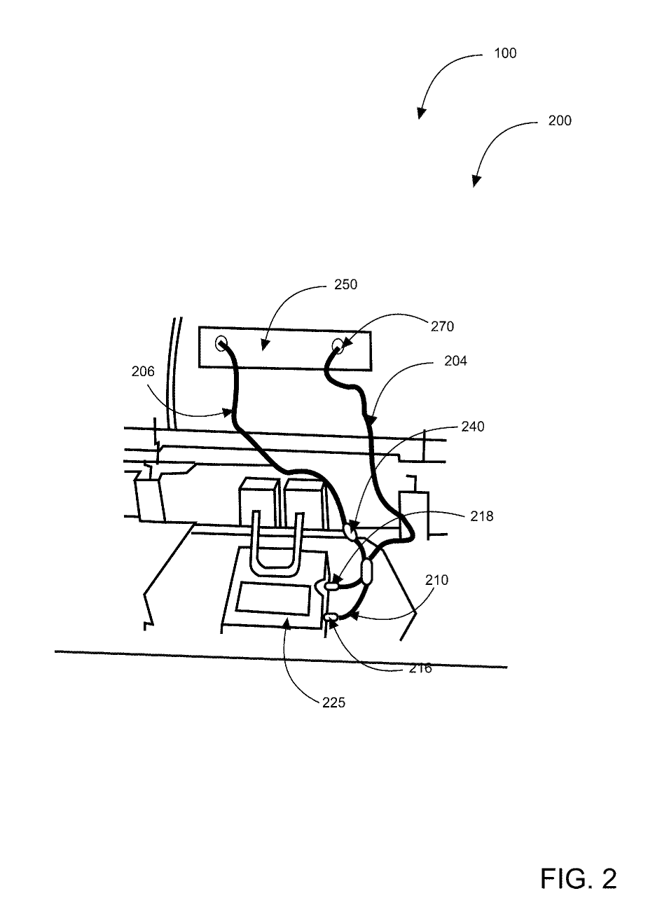

Now referring to FIG. 2, a perspective view illustrating wiring assembly 200 attached to 6-volt rechargeable battery 225 according to an embodiment of the present invention of FIG. 1. Wiring assembly 200 may comprise at least one positive wire 204, at least one negative wire 206, and at least one battery connector 210. As seen in FIG. 2, positive wire 204 and negative wire 206 of wiring assembly 200 are preferably connected to positive receiver 216 and negative receiver 218 of 6-volt rechargeable battery 225 respectively. Two cable installation holes 270 may be drilled into exterior surface of toy vehicle 140 preferably located directly underneath arrangement of photovoltaic panels 120. In such a manner, positive wire 204 and negative wire 206 of wiring assembly 200 may pass through cable installation holes 270 and into rear portion of photovoltaic panel 120. Wiring assembly 200 may be secured to photovoltaic panel 120 by wiring assembly fastening means 250. When installed to toy vehicle 140, wiring assembly 200 provides a conduit of electricity from photovoltaic panel 120 to 6-volt rechargeable battery 225.

As further shown in FIG. 2, negative wire 206 of wire assembly 200 may comprise at least one diode 240. In a preferred embodiment of the present invention, diode 240 may comprise a semi-conductor diode that may conduct electric current in only one direction. In this way, diode 240 may provide a forward bias direction of electricity from solar cells 130 to 6-volt rechargeable battery 225.

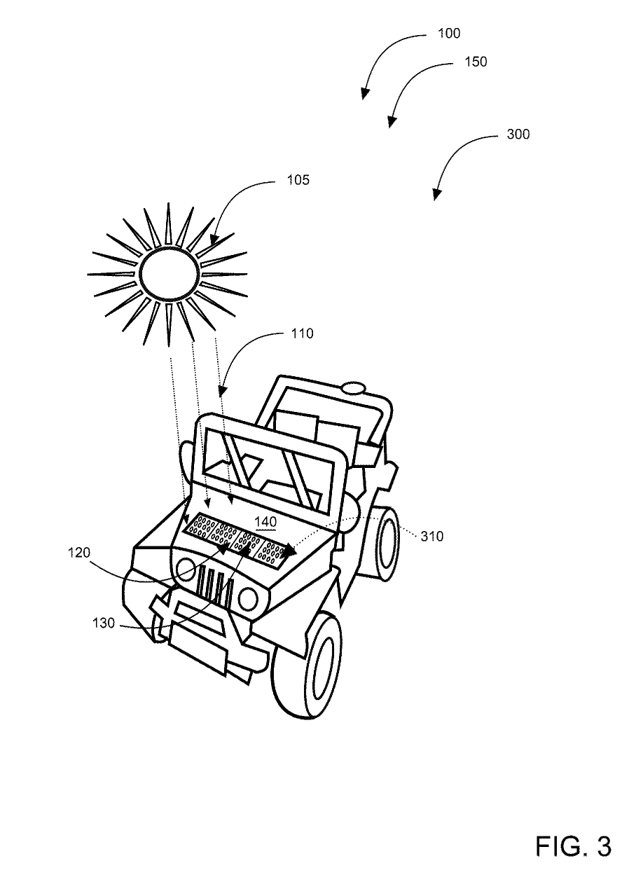

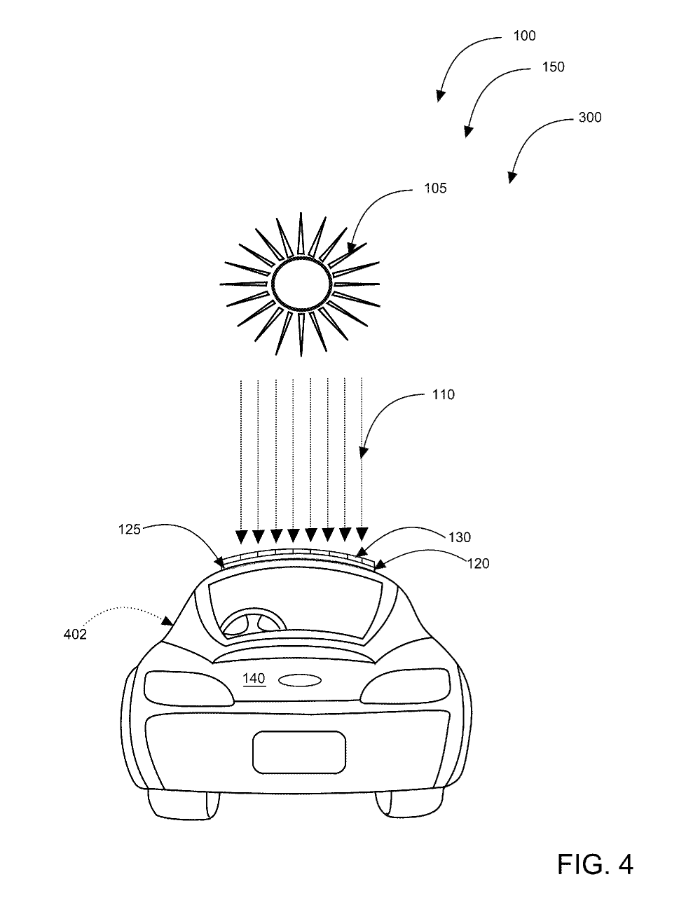

FIG. 3 is a perspective view illustrating solar powered recharging system 102 in an in-use condition 150 comprising an array of four photovoltaic panels 120 installed to an exterior surface of a toy vehicle 140 to power 12-volt rechargeable battery 310. Recharging process 300 comprises the process of converting sun light 110 into electricity. Solar cells 130 convert light into electric current using photoelectric effect. As best seen in FIG. 4, photovoltaic panel 120 may comprise a plurality of solar cells 130. Each solar cell 130 generates electric current when sun light 110 of sun 105 reaches photovoltaic panel 120. Sun light is converted by solar cell 130 and uni-directionally conducted through wiring assembly 200 to 6-volt rechargeable battery 225 or 12-volt rechargeable battery 310. Electricity may then be transferred from 6-volt rechargeable battery 225 or 12-volt rechargeable battery 310 to toy vehicle engine 310 thereby providing power to operate toy vehicle 140. Electricity may be rechargeably stored by 6-volt rechargeable battery 225 or 12-volt rechargeable battery 310 until it reaches full storage capacity. As toy vehicle 140 is being operated during sun light hours, 12-volt rechargeable battery 310 may retain maximum electricity storage while simultaneously powering toy vehicle 140. Diode 240 serves to prevent the drainage of power of 12-volt rechargeable battery 310.

FIGS. 3 and 4 further illustrate additional uses and alternative installation methods of sun sent power systems 100. As seen in FIG. 3, solar battery recharging assembly 102 may comprise four photovoltaic panels 120 installed to toy vehicle 140 comprising a power jeep. In the illustration of FIG. 3, photovoltaic panel 120 may comprise a rigid material having plurality of solar cells 130. As may be seen in FIG. 4, in an alternative embodiment of sun sent power systems 100, photovoltaic panel 120 is flexibly installable to toy vehicle 140 in the shape of a toy car. In such a manner, photovoltaic panel 120 may be contour-formed to match the shape of the top exterior surface toy vehicle 140. In a preferred location of installation, photovoltaic panel 120 may be faced upwardly thereby providing maximum exposure to sun 105.

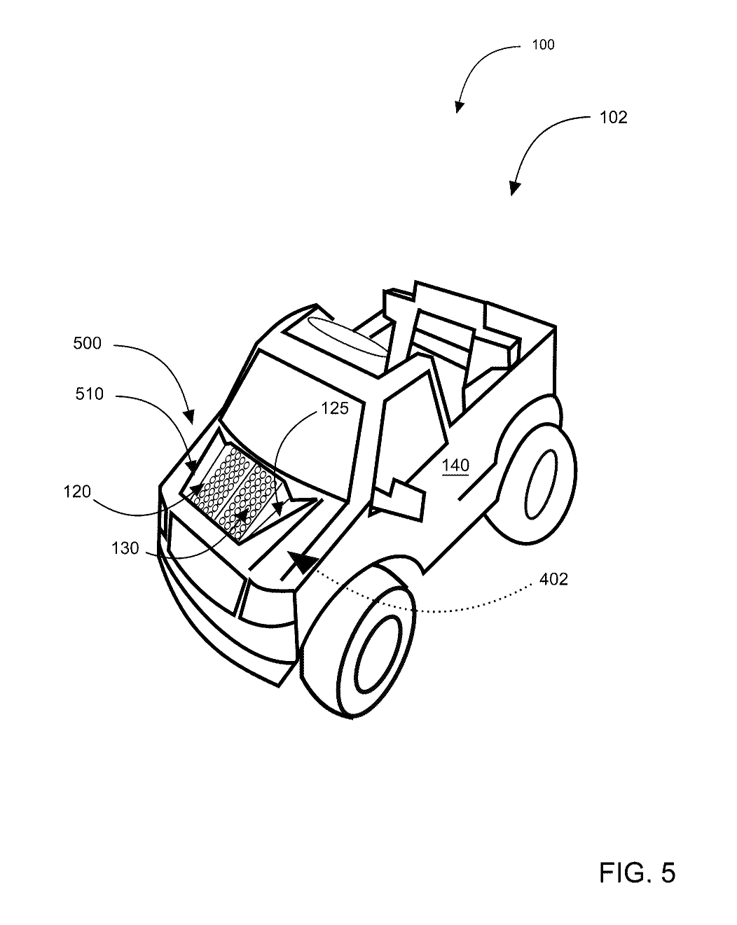

As seen in FIG. 5, add-on kit 500 may comprise heavy plastic, plexi-glass, or other suitable materials and may be securably installed to an existing toy vehicle 140. In one embodiment suitable for toy vehicles 140 requiring greater power, add-on kit 500 may comprise the following parts: at least one solar battery recharging assembly 102 having at least four photovoltaic panels 120; at least one fastener 125; at least one wiring assembly 200; at least one wiring assembly fastening means 250; at least one 12-volt rechargeable battery 310; at least one solar battery recharging housing 510; and at least one set of users instructions. Add-on kit 500 may be removably installed to a hood portion of toy vehicle 140. It should be appreciated that toy vehicle 140 includes, but is not limited to, a car, truck, mini-ATV, power scooter, and other comparable children's vehicles. Further, toy vehicle 140 may be powered from alternative power sources in conjunction with sun sent power systems thereby providing auxiliary power when needed. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different battery combinations, different host toys, parts may be sold separately, etc., may be sufficient.

It may be appreciated that the present invention may be compatible with a variety of brands of rechargeable batteries. In one embodiment, solar battery recharging assembly 102 may comprise 6-volt rechargeable battery 225 having a wet cell. In alternative embodiments, solar battery recharging assembly 102 may comprise 12-volt rechargeable battery 310 having a dry cell. Sun sent power systems 100 may be removably installable to a wide assortment of children's power toys of the vehicular and transporting kind. Photovoltaic panels 120 may comprise either flexible or rigid material thereby providing a contour-formed solar cell 130 surface to exterior of toy vehicles 140 comprising a variety of sizes and shapes.

Installation and use of sun sent power system 100 may be in ideal solution to provide continuous, non-stop power during optimal periods of use. Children often play outdoors using toy vehicles 140 during daylight hours. The sun sent power system 100 converts sun light 110 emitted by sun 105 into usable and storable electricity. Toy vehicle engine 402 preferably runs off power supplied 6-volt rechargeable battery 225 or 12-volt rechargeable battery 310 by battery which is constantly being recharged during in-use condition 150. Most parents typically only permit their children to play outdoors during daylight on toy vehicles 140 because it is generally unsafe for children to operate such toys at night when there is less visibility and a greater chance of being struck by a car. Therefore, sun sent power systems 100 ideally will provide all the power required by toy vehicle 140 without interruption.

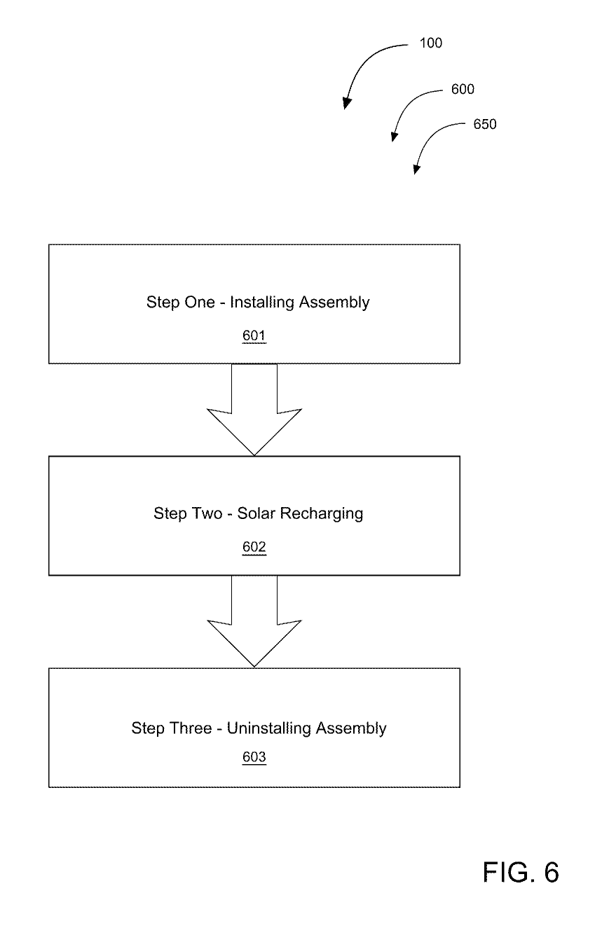

As seen in FIG. 6, method of use 600 of the present invention may comprise the steps of; step one 601 installing solar battery recharging assembly 102 to exterior region of toy vehicle 140; step two 602 recharging 12-volt rechargeable battery 310 via solar power; and step three 603 powering toy vehicle 140 via solar battery recharging assembly 102. A further step may include removal of solar battery recharging assembly 102. It should be noted that step three 603 is an optional step and may not be implemented in all cases.

Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A solar battery recharging system comprising;
at least one photovoltaic panel having an assembly of interconnected solar cells;
a wiring assembly;
at least one rechargeable battery;
at least one diode;
at least one fastener;
wherein said at least one photovoltaic panel is fastenable to an exterior surface of an electric toy vehicle;
wherein said assembly of interconnected solar cells converts photon energy into DC power that is routed through said wiring assembly to power and recharge said at least one rechargeable battery;
wherein said at least one diode ensures that said DC power flows in one direction from said at least one photovoltaic panel to said at least one rechargeable battery; and
wherein said DC power is used to rechargeably operate said electric toy vehicle.

2. The solar battery recharging system of claim 1, wherein said at least one photovoltaic panel, said wiring assembly, said at least one rechargeable battery, said at least one diode, and said at least one fastener comprise a solar battery recharging assembly.

3. The solar battery recharging system of claim 1, wherein said at least one photovoltaic panel is rigid.

4. The solar battery recharging system of claim 1, wherein said at least one photovoltaic panel is flexible.

5. The solar battery recharging system of claim 4, wherein said at least one photovoltaic panel is contour-formed to match said exterior surface of said electric toy vehicle.

6. The solar battery recharging system of claim 1, wherein said at least one photovoltaic panel comprises a weather resistant enclosure suitable for outdoor use.

7. The solar battery recharging system of claim 1, wherein said at least one photovoltaic panel is removably mountable to a top surface of said exterior surface of said electric toy vehicle.

8. The solar battery recharging system of claim 2, wherein said solar battery recharging assembly is retrofittably installable to an existing said electric toy vehicle.

9. The solar battery recharging system of claim 8, wherein said solar battery recharging assembly includes said at least one fastener comprising doubled-sided mounting tape for affixing said at least one photovoltaic panel to said exterior surface of said electric toy vehicle.

10. The solar battery recharging system of claim 8, wherein said solar battery recharging assembly includes said at least one fastener comprises a hook and loop fastener for removably affixing said at least one photovoltaic panel to said exterior surface of said electric toy vehicle.

11. The solar battery recharging system of claim 2, wherein said solar battery recharging assembly is manufactured OEM in said electric toy vehicle.

12. The solar battery recharging system of claim 1, wherein said at least one diode is in communication with positive wires on said wiring assembly to prevent power drainage of said at least one rechargeable battery during periods of non-use.

13. The solar battery recharging system of claim 1, wherein said rechargeable batteries are 6-volts.

14. The solar battery recharging system of claim 1, wherein said rechargeable batteries are 12-volts.

15. The solar battery recharging system of claim 13, wherein said 6-volt configuration is chargeable via two of said photovoltaic panels.

16. The solar battery recharging system of claim 14, wherein said 12-volt configuration is chargeable via four of said photovoltaic panels.

17. The solar battery recharging system of claim 1, wherein said rechargeable batteries comprises secondary batteries having at least one dry cell.

18. A solar battery recharging system comprising:
at least one photovoltaic panel having an assembly of interconnected solar cells wherein said interconnected solar cells convert photon energy into DC power;
a wiring assembly comprising at least one positive wire, at least one negative wire comprising at least one diode, at least one battery connector, and at least one wiring assembly fastening means;
at least one rechargeable battery;
at least one fastening means;
wherein said at least one photovoltaic panel, said wiring assembly, said at least one rechargeable battery, said at least one fastener means comprise a solar battery recharging assembly;
wherein an array of said at least one photovoltaic panels are fastenable to an exterior surface of an electric toy vehicle via said at least one fastening means;
wherein said wiring assembly conducts said DC power generated by said assembly of interconnected solar cells to power and recharge said at least one rechargeable battery;
wherein said at least one diode insures that said DC power flows in one direction from said at least one photovoltaic panel to said at least one rechargeable battery; and
wherein said DC power is used to operate said electric toy vehicle.

19. The solar battery recharging system of claim 18, wherein said at least one photovoltaic panel, said wiring assembly, said at least one rechargeable battery, said at least one diode and at least one photovoltaic panel fastening means comprises a kit.

20. A method of use for a solar battery recharging system comprising the steps of;
installing a solar battery recharging assembly to an exterior surface of a toy vehicle;
solar charging a rechargeable battery; and
powering the electric toy.
